(19) United States
(12) Patent Application Publication
(10) Pub. No.: US 2022/0365985 A1
(43) Pub. Date: Nov. 17, 2022

(54) PAGE JUMP METHOD AND APPARATUS, ELECTRONIC DEVICE AND COMPUTER-READABLE STORAGE MEDIUM

(71) Applicant: BEIJING BYTEDANCE NETWORK TECHNOLOGY CO., LTD., Beijing (CN)

(72) Inventor: Jingyuan ZHU, Beijing (CN)

(21) Appl. No.: 17/767,030

(22) PCT Filed: Aug. 7, 2020
(86) PCT No.: PCT/CN2020/107667

§ 371 Date: Apr. 6, 2022

(30) Foreign Application Priority Data
Oct. 8, 2019 (CN) 201910947866.6

(51) Int. Cl. G06F 16/954; G06F 16/957; G06F 16/955

(52) U.S. Cl. CPC G06F 16/954; G06F 16/957; G06F 16/955

(57) ABSTRACT

A page jump method and a page jump apparatus are provided. The method includes: displaying a first page, where the first page includes a jump component, and the jump component is associated with multiple jump links; performing a jump link acquisition operation if a trigger signal of the jump component is received, and acquiring a to-be-jumped link from the multiple jump links through the jump acquisition operation; performing a jump operation so that the first page jumps to a second page associated with the to-be-jumped link; and performing, if the jump operation fails, the jump link acquisition operation and the jump operation again, until the jump operation succeeds or there is no to-be-jumped link.

### CROSS REFERENCE OF RELATED APPLICATION

The present application claims the priority to Chinese Patent Application No. 201910947866.6, titled “PAGE JUMP METHOD AND APPARATUS, ELECTRONIC DEVICE AND COMPUTER READABLE STORAGE MEDIUM”, filed on Oct. 8, 2019 with the State Intellectual Property Office of the PRC, which is incorporated herein by reference in its entirety.

### FIELD

The present disclosure relates to the field of page processing, and in particular to a a page jump method and apparatus, an electronic device and a computer readable storage medium.

### BACKGROUND

With the development of a computer network and popularity of a mobile phone, a user generally browses contents in the network by using a terminal device. Generally, the user browses pictures, words, videos and audios in the network by accessing a web page. Therefore, it is required to design or develop related pages in advance by the designer or the developer. The page is released only when contents are filled and well arranged in the page. The user accesses the page through a network address of the page.

In the conventional art, a landing page for H5 is generally provided with some components for clicking by the user. The component is generally provided with a jump address in advance. When the user clicks the address, the page jumps to a page associated with the address. Typically, a watching address of a video is displayed on a video recommendation page, and the page can jump to a page associated with the address for watching the video when the user clicks the address. In fact, in the conventional art, the terminal devices have multiple types and different types of terminal devices adapt to different system running environments, resulting in that jumping fails on some terminal devices according to a preset jump address.

### SUMMARY

This section is provided to introduce the concept briefly, and the concept is described in detail in specific embodiments hereinafter. This section is neither intended to identity key features or necessary features of the claimed technical solutions, not intended to limit scope of the claimed technical solutions.

In a first aspect, a page jump method is provided according to embodiments of the present disclosure. The method includes:

displaying a first page, where the first page includes a jump component, and the jump component is associated with multiple jump links;

performing a jump link acquisition operation if a trigger signal of the jump component is received, and acquiring a to-be-jumped link from the multiple jump links through the jump link acquisition operation;

performing a jump operation so that the first page is jumped to a second page associated with the to-be-jumped link; and

performing, if the jump operation fails, the jump link acquisition operation and the jump operation again, until the jump operation succeeds or there is no to-be-jumped link.

In a second aspect, a page jump apparatus is provided according to embodiments of the present disclosure. The apparatus includes a page display module, a jump link acquisition module, a jump operation execution module and a jump failure processing module.

The page display module is configured to display a first page. The first page includes a jump component, and the jump component is associated with multiple jump links.

The jump link acquisition module is configured to perform a jump link acquisition operation if a trigger signal of the jump component is received, and acquire a to-be-jumped link from the multiple jump links through the jump link acquisition operation.

The jump operation execution module is configured to perform a jump operation, so that the first page jumps to a second page associated with the to-be-jumped link.

The jump failure processing module is configured to perform, if the jump operation fails, the jump link acquisition operation and the jump operation again, until the jump operation succeeds or there is no to-be-jumped link.

In a third aspect, an electronic device is provided according to embodiments of the present disclosure. The electronic device includes: at least one processor; and a memory in communication connection with the at least one processor. The memory stores instructions executable by the at least one processor. The instructions, when being executed by the at least one processor, instruct the at least one processor to perform the page jump method according to the first aspect.

In a fourth aspect, a non-transitory computer readable storage medium is provided according to embodiments of the present disclosure. The non-transitory computer readable storage medium stores computer instructions for instructing a computer to perform the page jump method according to the first aspect.

The page jump method and apparatus, the electronic device and the computer readable storage medium are provided according to the present disclosure. The page jump method includes: displaying a first page, where the first page includes a jump component, and the jump component is associated multiple jump links; performing a jump link acquisition operation if a trigger signal of the jump component is received, and acquiring a to-be-jumped link from the multiple jump links through the jump link acquisition operation; performing a jump operation so that the first page jumps to a second page associated with the to-be-jumped link; and performing, if the jump operation fails, the the jump link acquisition operation and the jump operation again, until the jump operation succeeds or there is no to-be-jumped link. With the above method, the technical problem in the conventional art that the page jump fails due to environment difference of terminal devices is solved.

The summary of the technical solutions of the present disclosure is described above. In order to understand the technical solutions of the present disclosure clearer and make the above and other objects, features and advantages of the present disclosure more apparent and easier to be understood, preferred embodiments of the present disclosure are described in detail with reference to the drawings hereinafter.

### BRIEF DESCRIPTION OF THE DRAWINGS

With reference to the drawings and specific embodiments below, the above and other features, advantages and aspects of the present disclosure become more apparent. Throughout the drawings, the same or similar reference numerals indicate the same or similar elements. It should be understood that the drawings are schematic, and components and elements are unnecessarily drawn in scale.

FIG. 1 is a flowchart of a page jump method according to an embodiment of the present disclosure;

FIG. 2 is a schematic diagram of a first page and components in the first page according to the present disclosure;

FIG. 3 is a a flowchart of step 102 of the page jump method according to the present disclosure;

FIG. 4 is a flowchart of step S103 of the page jump method according to the present disclosure;

FIG. 5 is a flowchart of a page jump method according to another embodiment of the present disclosure;

FIG. 6 is a flowchart of step S104 of the page jump method according to the present disclosure;

FIG. 7 is a schematic structural diagram of a page jump apparatus according to an embodiment of the present disclosure; and

FIG. 8 is a schematic structural diagram of an electronic device according to an embodiment of the present disclosure.

### DETAILED DESCRIPTION

Embodiments of the present disclosure are described in detail hereinafter with reference to the drawings. Although the drawings show some embodiments of the present disclosure, it should be understood that the present disclosure may be implemented by various embodiments and are not limited to be implemented by the embodiments clarified herein. The embodiments described in the present disclosure are intended to illustrate the present disclosure thoroughly and completely. It should be understood that the drawings and the embodiments are only schematic, and are not intended to limit the protection scope of the present disclosure.

It should be understood that, steps described in the embodiments of the present disclosure may be performed in different orders and/or performed in parallel. In addition, the method embodiments may include additional steps and/or steps omitted. The scope of the present disclosure is not limited thereto.

Term “including” and variations thereof adopted herein is inclusive, that is “including but not limited to”. The term “based on” means “at least partially based on”. The term “one embodiment” means “at least one embodiment”, and the term “another embodiment” means “at least another embodiment”. The term “some embodiments” means “at least some embodiments”. Definitions of other terms are provided below.

It should be noted that, the terms “first”' “second” and so on mentioned in the present disclosure are only used to distinguish different apparatuses, modules or units, rather than limit an order of functions performed by the apparatus, module or unit or limit interdependence.

It should be noted that, the terms “one” and “multiple” mentioned in the present disclosure are schematic rather than restrictive, and should be understood as “one or more” by those skilled in the art, otherwise explicitly illustrated in the context.

Names of messages or information interacted between multiple apparatuses in the embodiments of the present disclosure are illustrative rather than limit the scope of the message or information.

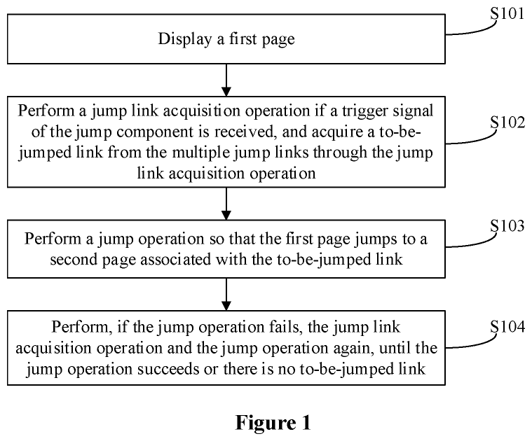

FIG. 1 is a flowchart of a page jump method according to an embodiment of the present disclosure. The page jump method in this embodiment may be performed by a page jump apparatus. The page jump apparatus may be implemented as software, or a combination of software and hardware. The page jump apparatus may be integrated in a certain device of a page jump system, for example, a page jump server or a page jump terminal device. As shown in FIG. 1, the method includes steps S101 to S104 in the following.

In step S101, a first page is displayed.

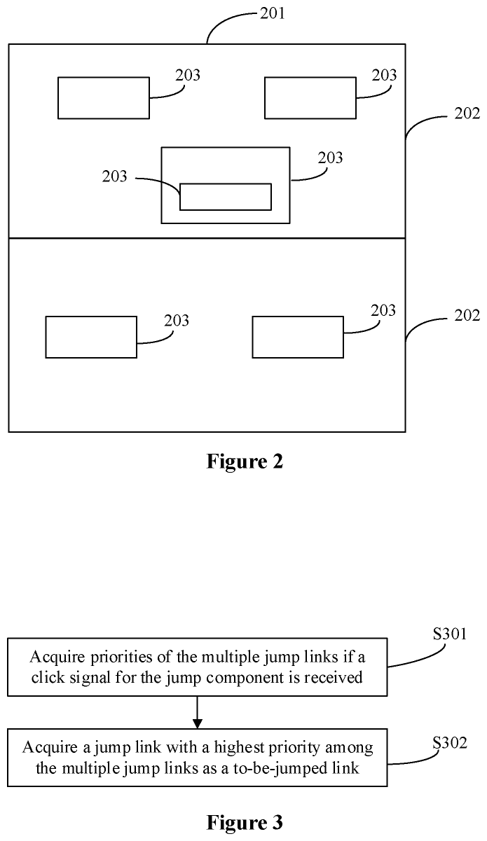

In the present disclosure, the first page includes multiple types of components. FIG. 2 shows a schematic diagram of a type first page. In FIG. 2, 201 indicates a first page, 202 indicates modules in the page, and 203 indicates components in the modules. The components include at least one or more of a word component, a picture component, a video component and a jump component. In editing a page, a module may be established first; various components are then established in the module to display different types of content. One page may include one or more modules.

In the present disclosure, the first page includes a jump component, and the jump component is associated with multiple jump links. The jump links includes multiple types of links, for example fast application link, APP link and web page link. In the present disclosure, each jump component may be associated with multiple jump links. That is, multiple jump links are set in one jump component. Typically, the jump component is a jump button.

In an embodiment, before step S101, the method further includes: receiving a setting signal of the jump component. The setting signal is used for setting multiple jump links associated with the jump component. In this step, a setting signal inputted via a human-machine interface by a user may be received. The setting signal carries a jump link and a priority of the jump link and so on. After receiving the setting signal, the terminal device associates the jump link with the jump component. Typically, the jump link may be stored in a terminal device in a form of an array or a list.

In step S102, if a trigger signal of the jump component is received, a jump link acquisition operation is performed; and a to-be-jumped link is acquired from the multiple jump links through the jump link acquisition operation.

In an embodiment, the trigger signal of the jump component is a click signal for the the jump component. The process of performing, if a trigger signal of the jump component is received, a jump link operation, and acquiring a to-be-jumped link from multiple jump links through the jump link acquisition operation includes steps S301 and step S302.

In step S301, if a click signal for the jump component is received, priorities of the multiple jump links are acquired.

In step 302, a jump link with a highest priority among the multiple jump links is acquired as the to-be-jumped link.

In the embodiment, each jump link has a jump priority. The priority may be set according to a type of the jump type by default, or may be set when editing the jump component in the page. After the click signal for the jump component is received, priorities of multiple jump links associated with the jump component are acquired, and the acquired priorities are ranked. A jump link with a highest priority among the multiple jump links is selected as the to-be-jumped link.

It should be understood that, in the present disclosure, the jump links may be ranked according to the priorities in the array or in the list. In this case, a jump link ranked foremost in the array or the list is acquired.

In step S103, a jump operation is performed, so that the first page is jumped to a second page associated with the to-be-jumped link.

In the present disclosure, the process of performing a jump operation includes: jumping from the first page to the second page associated with the to-be-jumped link according to the to-be-jumped link.

In an embodiment, the process of performing a jump operation so that the first page is jumped to a second page associated with the to-be-jumped link includes steps S401 and S402.

In step S401, a type of the to-be-jumped link is determined.

In step S402, programs corresponding to the type of the to-be-jumped link are invoked to open the to-be-jumped link.

In the embodiment, each jump link has a corresponding type, the multiple jump links have different types, and the type of the jump link is determined according to an opening manner of the to-be-jumped link. In performing the jump operation, the type of the acquired to-be-jumped link is determined; and then the programs corresponding to the type are invoked to open the to-be-jumped link so as to jump to the second page associated with the to-be-jumped link. Typically, the type of the jump links includes: fast application jump link, APP jump link and web page link. For the fast application jump link, the jump link is opened through a fast application; for the APP jump link, the jump link is opened through an APP client; and for the web page jump link, the jump link is opened through a browser.

In step S104, if the jump operation fails, the jump link acquisition operation and the jump operation are performed again, until the jump operation succeeds or there is no to-be-jumped link.

In the present disclosure, the jump operation in step S103 may succeed or fail. In step S103, in a case that the jump operation fails, that is, it fails to jump from the first page to the second page, the jump link acquisition operation is performed again. In this case, the jump link which fails to be jumped to may be deleted from the array or list of jump links, and then a jump link ranked foremost currently in the array or the list is acquired. Alternatively, a next jump link of the jump link which fails to be jumped to is acquired directly from the array or the list. The method for acquiring the next jump link is the same as that described in step S102, and details are not described herein. Subsequently, the jump operation is performed continuously according to the newly acquired to-be-jumped link, until the jump succeeds or there is no to-be-jumped link in the array or the list.

In an embodiment, after the process of performing the jump link acquisition operation in step S102, the method further includes steps S501 and S502.

In step S501, it is determined whether a type of a terminal device where the first page is located matches with the to-be-jumped link.

In step S502, if the type of the terminal device does not match with the to-be-jumped link, the jump link acquisition operation is performed again.

In an embodiment, in step S501, after the to-be-jumped link is acquired in step S102, a type of the to-be-jumped link is determined. In the embodiment, each jump link has a corresponding type, and the type is associated with a type of a terminal of the user. Typically, the jump link is a fast application jump link corresponding to a terminal of the android system; or the jump link is an APP jump link corresponding to a terminal of the android system of the Mac OS; or the jump link is a web page jump link corresponding to a terminal of the android system or the Mac OS. After the type of the to-be-jumped link is acquired, it is determined whether the type matches with the type of the terminal device where the first page is located. If the current terminal device is a terminal installed with the Mac os and the to-be-jumped link is the fast application jump link, the to-be-jumped link does not match with the type of the terminal device. That is, the terminal device displaying the first page cannot open the to-be-jumped link, step S502 is performed. That is, the jump link acquisition operation in step S102 is performed again to acquire a next jump link. The method of acquiring the next jump link is the same as that described in step S102, and details are not described herein. It should be understood that, in a case that the type of the terminal device matches with the to-be-jumped link, the jump operation is performed directly, and details are not described herein. Through the above step, it may be determined whether the terminal of the first page is capable of opening the currently acquired to-be-jumped link before performing jump, thereby omitting meaningless jump operations and thus increasing a speed of the jumping.

In an embodiment, the process of performing a jump operation so that the first page jumps to a second page associated with the to-be-jumped link in step S103 includes:

starting a first timer; and

invoking programs corresponding to the to-be-jumped link to open the to-be-jumped link.

The process of performing, if the jump operation fails, the jump link acquisition operation and the jump operation again, until the jump operation succeeds or there is no to-be-jumped link in step S104 includes steps S601 and S602 below.

In step S601, when the first timer times outs, it is determined whether a page currently displayed is the first page.

In step S602, if the page currently displayed is the first page, the jump link acquisition operation and the jump operation are performed again, until the jump operation succeeds or there is no to-be-jumped link.

In the embodiment, it is determined whether the jumping fails by using the timer. The first timer is started when the jump operation is performed. A longest time of the jumping is determined according to the first timer. Typically, the first timer times outs when 2 seconds expire. When the first timer times out, it is determined whether the page currently displayed is the first page. Typically, it may be determined whether the page currently displayed is the first page based on an activation state of the page. Pages displayed are located at foreground, and an identifier may be set to indicate the page located at foreground. If an identifier of the first page indicates that the first page is located at foreground, the page currently displayed is the first page. That is, before the first timer times out, it fails to jump to the second page, i.e., the jumping fails. In this case, the jump link acquisition operation is performed again to acquire a next to-be-jumped link, and the jump operation is performed according to the next to-be-jumped link, until the jump operation succeeds or there is no to-be-jumped link.

With the above page jump method, a same jump component is associated with multiple different types of jump links. If the jumping fails for one type of jump link, multiple times of jumping are performed by using other types of jump links. Therefore, the method is applicable to multiple different types of terminals, thereby reducing a probability of the jump failure.

The page jump method and apparatus, the electronic device and the computer readable storage medium are provided according to the present disclosure. The page jump method includes: displaying a first page, where the first page includes a jump component, and the jump component is associated with multiple jump links; performing a jump link acquisition operation if a trigger signal of the jump component is received, and acquiring a to-be-jumped link from the multiple jump links through the jump link acquisition operation; performing a jump operation so that the first page jumps to a second page associated with the to-be-jumped link; and performing, if the jump operation fails, the the jump link acquisition operation and the jump operation again, until the jump operation succeeds or there is no to-be-jumped link. With the above method, the technical problem in the conventional art that the page jump fails due to environment difference of terminal devices is solved.

Although steps in the method embodiments are described above in the above order, those skilled in the art should know that steps in the embodiments of the present disclosure are unnecessarily performed in the above order, and the steps may be performed in a reverse order, in parallel or in other manners. Those skilled in the art may add other steps based on the above steps. These apparent variations or equivalent replacements should fall within the protection scope of the present disclosure, and details are not described herein.

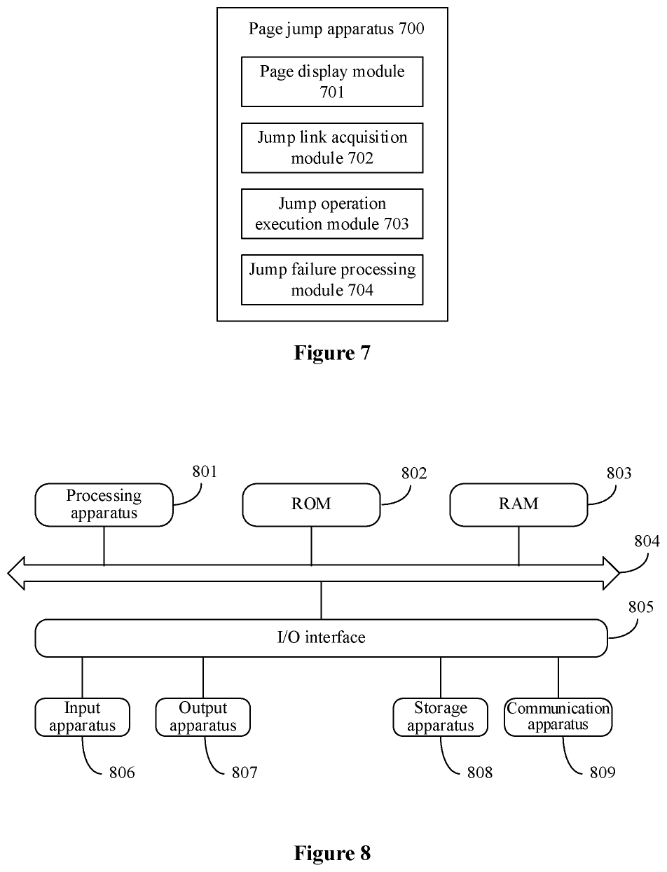

FIG. 7 is a schematic structural diagram of a page jump apparatus according to an embodiment of the present disclosure. As shown in FIG. 7, the apparatus 700 includes: a page display module 701, a jump link acquisition module 702, a jump operation execution module 703 and a jump failure processing module 704.

The page display module 701 is configured to display a first page. The first page includes a jump component, and the jump component is associated with multiple jump links.

The jump link acquisition module 702 is configured to perform a jump link acquisition operation if a trigger signal of the jump component is received, and acquire a to-be-jumped link from the multiple jump links through the jump link acquisition operation.

The jump operation execution module 703 is configured to perform a jump operation, so that the first page jumps to a second page associated with the to-be-jumped link.

The jump failure processing module 704 is configured to perform, if the jump operation fails, the jump link acquisition operation and the jump operation again, until the jump operation succeeds or there is no to-be-jumped link.

The jump link acquisition module 702 includes a priority acquiring module and a to-be-jumped link acquisition module.

The priority acquisition module is configured to acquire priorities of the multiple jump links if a click signal for the jump component is received.

The to-be-jumped link acquisition module is configured to acquire a jump link with a highest priority among the multiple jump links as the to-be-jumped link.

The jump operation execution module 703 includes a jump link type determination module and a first invoking module.

The jump link type determining module is configured to determine a type of the to-be-jumped link.

The first invoking module is configured to invoke programs corresponding to the type of the to-be-jumped link to open the to-be-jumped link.

The page jump apparatus 700 further includes a match determining module and a first jump link acquisition module.

The match determining module is configured to determine whether a type of a terminal device where the first page is located matches with the to-be-jumped link.

The first jump link acquisition module is configured to perform the jump link acquisition operation again, if the type of the terminal device does not match with the to-be-jumped link.

The jump operation execution module 703 includes a timer starting module and a second invoking module.

The timer starting module is configured to start a first timer.

The second invoking module is configured to invoke programs corresponding to the to-be-jumped link to open the to-be-jumped link.

The jump failure processing module 704 includes a first page determining module and a first jump failure processing module.

The first page determining module is configured to determine whether a page currently displayed is the first page if the first timer times out.

The first jump failure processing module is configured to perform the jump link acquisition operation and the jump operation again if the page currently displayed is the first page, until the jump operation succeeds or there is no to-be-jumped link.

The page jump apparatus 700 further includes a setting signal receiving module.

The setting signal receiving module is configured to receive a setting signal of the jump component. The setting signal is used for setting multiple jump links associated with the jump component.

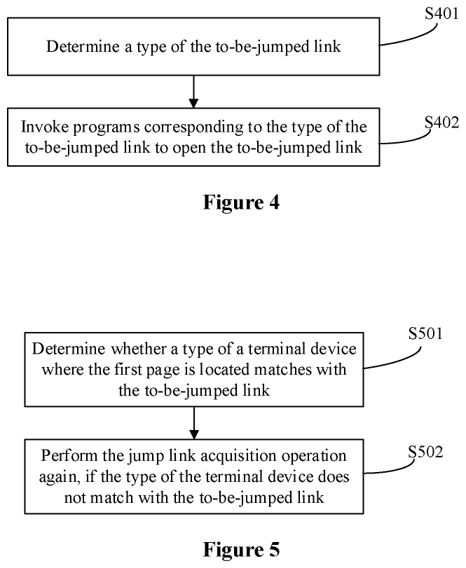

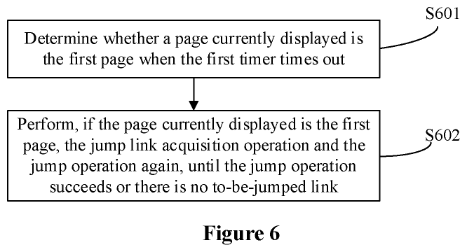

The apparatus shown in FIG. 7 may perform the method in embodiments shown in FIG. 1 to FIG. 6. For content not described in detail in this embodiment, one may refer to related illustration in the embodiments shown in FIG. 1 to FIG. 6. For the performing process and the technical effect of the technical solution shown in FIG. 7, one may refer to the description in the embodiments shown in FIG. 1 to FIG. 6, and details are not described herein.

Reference is made to FIG. 8 which shows a schematic structural diagram of an electronic device 800 for implementing the embodiments of the present disclosure. The terminal device in the embodiments of the present disclosure may include but not limited to mobile terminals such as a mobile phone, a notebook computer, a digital broadcast receiver, a personal digital assistance (PDA), a tablet computer (PAD), a portable multi-media player (PMP) and a vehicle terminal (such as a vehicle navigation terminal); and fixed terminals such as digital TV and a desktop computer. The electronic device shown in FIG. 8 is schematic, and is not intended to limit functions and scope of the embodiments of the present disclosure.

As shown in FIG. 8, the electronic device 800 may include a processing apparatus (such as a central processor and a graphic processor) 801. The processing apparatus may perform various appropriate actions and processing by executing programs stored in a read-only memory (ROM) 802 or programs uploaded from a storage apparatus 806 to a random access memory (RAM) 803. Various programs and data required for operations of the electronic device 800 are also stored in the RAM 803. The processing apparatus 801, the ROM 802 and the RAM 803 are connected to each other through the bus 804. An input/output (I/O) interface 805 is also connected to the bus 804.

Generally, the following components are connected to the I/O interface 805: an input apparatus 806 such as a touch screen, a touch panel, a keyboard, a mouse, a camera, a microphone, an accelerometer, and gyroscope; an output apparatus 807 such as a liquid crystal display (LCD), a loudspeaker and a vibrator; a storage apparatus 806 such as a magnetic tape and a hard disk; and a communication apparatus 809. The communication apparatus 809 may allow the electronic device 800 to communicate with other device in a wired or wireless manner to exchange data. Although FIG. 8 shows the electronic device 800 provided with various apparatuses, it should be understood that not all shown apparatuses are necessary. Alternatively, more or less apparatuses may be included.

According to the embodiments of the present disclosure, a process described in the flowchart may be implemented by computer software programs. For example, according to an embodiment of the present disclosure, a computer program product including computer program carried on a non-transitory computer readable medium is provided. The computer program includes program codes for performing the method shown in the flowchart. In such embodiment, the computer program may be downloaded and installed from the network through the communication apparatus 809, installed from the storage apparatus 806 or installed from the ROM 802. The computer program is executed by the processing apparatus 801 to perform functions defined in the methods described in the embodiments of the present disclosure.

It should be noted that, the computer readable medium described in the present disclosure may be a computer readable signal medium, a computer readable storage medium or any combination thereof. The computer readable storage medium may include but not limited to a system, an apparatus or a device in an electric, magnetic, optical, electromagnetic, infrared or a semiconductor form, or any combination thereof. The computer readable storage medium may include but not limited to electric connection of one or more wires, a portable computer magnetic disk, a hard disk, a random access memory (RAM), a read-only memory (ROM), an erasable programmable read only memory (EPROM or a flash memory), an optical fiber, a portable compact disk read only memory (CD-ROM), an optical storage device, a magnetic storage device or any combination thereof. In the present disclosure, the computer readable storage medium may be a tangible medium including or storing programs. The programs may be used by an instruction execution system, apparatus or device, or may be used in combination with the instruction execution system, apparatus or device. In the present disclosure, a computer readable signal medium may include a data signal in a baseband or propagated as a part of carrier. The computer readable signal medium carries computer readable program codes. The propagated data signal may include but not limited to an electromagnetic signal, an optical signal or any combination thereof. The computer readable signal medium may be any computer readable medium other than the computer readable storage medium. The computer readable signal medium may send, propagate or transmit programs used by the instruction execution system, apparatus or device or the programs used in combination with the instruction execution system, apparatus or device. The program code included in the computer readable medium may be transmitted via any appropriate medium, including but not limited to an electric wire, an optical fiber, radio frequency (RF) or any appropriate combination thereof.

In some embodiments, the client and the server may perform communication by using any known network protocol such as Hyper Text Transfer Protocol (HTTP) or any network protocol to be developed, and may connect with digital data in any form or carried in any medium (for example, a communication network). The communication network includes a local area network (LAN), a wide area network (WAN), an international network (for example the internet), a peer-to-peer network (for example ad hoc peer-to-peer network), and any known network or network to be developed.

The computer readable storage medium may be included in the electronic device, or the computer readable storage medium may be independent from the electronic device, i.e., not being installed in the electronic device.

The computer readable medium carries one or more programs. When the one or more programs are executed by the electronic device, the electronic device is instructed to perform the following operations: displaying a first page, where the first page includes a jump component, and the jump component is associated with multiple jump components; performing a jump link acquisition operation if a trigger signal of the jump component is received, and acquiring a to-be-jumped link from the multiple jump links through the jump link acquisition operation; performing a jump operation so that the first page jumps to a second page associated with the to-be-jumped link; and performing, if the jump operation fails, the jump link acquisition operation and the jump operation again, until the jump operation succeeds or there is no to-be-jumped link.

Computer program codes for performing operations of the present disclosure may be written by using one or more program design language or any combination. The program design language includes but not limited to object oriented program design language such as Java, Smalltalk and C++, and further includes conventional process-type program design language such as “C” or similar program design language. The program codes may be completely or partially executed on a user computer, performed as an independent software packet, partially executed on the user computer and partially executed on a remote computer, or completely executed on the remote computer or a server. In a case of involving the remote computer, the remote computer may connect to the user computer via any type of network such as a local area network (LAN) and a wide area network (WAN). Alternatively, the remote computer may connect to an external computer (such as achieving internet connection by services provided by the internet network service provider).

The flowcharts and block diagrams shown in the drawings show a system architecture, function and operation which may be implemented by the system, method and computer program product according to the embodiments of the present disclosure. Each block in the flowcharts or the block diagram may represent a part of a module, a program section or codes including executable instructions for implementing specified logic functions. It should be noted that, in alternative embodiment, functions denoted in the blocks may be performed in an order different from the order denoted in the drawing. For example, operations in two blocks connected successively may be performed in parallel, or may be performed in an opposite order, depending on the involved function. It should be noted that, each block in the block diagrams and/or flowcharts, and a combination of blocks in the block diagrams and/or flowcharts may be implemented by a dedicated hardware system for performing specified functions or operations, or may be implemented by a combination of dedicated hardware and computer instructions.

Units involved in the embodiments of the present disclosure may be implemented by software or hardware. Names of the units do not limit the units in a certain case.

The functions described above may be partially performed by one or more hardware logic components. For example, the hardware logic components include: a field programmable gate array (FPGA), an application specific integrated circuit (ASIC), an application specific standard product (ASSP), a system on chip (SOC), a complex programmable logic device (CPLD) and so on.

It the context of the present disclosure, the computer readable medium may be a tangible medium including or storing programs. The programs may be used by an instruction execution system, apparatus or device, or may be used in combination with the instruction execution system, apparatus or device. The machine readable medium may be a machine readable signal medium or a machine readable storage medium. The machine readable storage medium may include but not limited to a system, an apparatus or a device in an electric, magnetic, optical, electromagnetic, infrared or a semiconductor form, or any combination thereof. The machine readable storage medium may include but not limited to electric connection of one or more wires, a portable computer magnetic disk, a hard disk, a random access memory (RAM), a read-only memory (ROM), an erasable programmable read only memory (EPROM or a flash memory), an optical fiber, a portable compact disk read only memory (CD-ROM), an optical storage device, a magnetic storage device or any combination thereof.

According to one or more embodiments of the present disclosure, a page jump method is provided. The method includes: displaying a first page, where the first page includes a jump component, and the jump component is associated with multiple jump links; performing, if a trigger signal of the jump component is received, a jump link acquisition operation, and acquiring a to-be-jumped link from the multiple jump links through the jump link acquisition operation; performing a jump operation so that the first page jumps to a second page associated with the to-be-jumped link; and performing, if the jump operation fails, the jump link acquisition operation and the jump operation again, until the jump operation succeeds or there is no to-be-jumped link.

The process of performing, if a trigger signal of the jump component is received, a jump link acquisition operation, and acquiring a to-be-jumped link from the multiple jump links through the jump link acquisition operation includes: acquiring priorities of the multiple jump links if a click signal for the jump component is received; and acquiring a jump link with a highest priority among the multiple jump links as the to-be-jumped link.

The process of performing a jump operation so that the first page jumps to a second page associated with the to-be-jumped link includes: determining a type of the to-be-jumped link; and invoking programs corresponding to the type of the to-be-jumped link to open the the to-be-jumped link.

After the jump link acquisition operation is performed, the method further includes: determining whether a type of a terminal device where the first page is located matches with the to-be-jumped link; and performing the jump link acquisition operation again if the type of the terminal device does not match with the to-be-jumped link.

The process of performing a jump operation so that the first page jumps to a second page associated with the to-be-jumped link includes: starting a first timer; and invoking programs corresponding to the to-be-jumped link to open the to-be-jumped link.

The process of performing, if the jump operation fails, the jump link acquisition operation and the jump operation again, until the jump operation succeeds or there is no to-be-jumped link includes: determining whether a page currently displayed is the first page if the first timer times out; and performing the jump link acquisition operation and the jump operation again if the page currently displayed is the first page, until the jump operation succeeds or there is no to-be-jumped link.

Before displaying the first page, the method further includes: receiving a setting signal of the jump component, where the setting signal is used for setting multiple jump links associated with the jump component.

According to one or more embodiments of the present disclosure. A page jump apparatus is provided. The apparatus includes: a page display module, a jump link acquisition module, a jump operation execution module, and a jump failure processing module.

The page display module is configured to display a first page. The first page includes a jump component, and the jump component is associated with multiple jump links.

The jump link acquisition module is configured to perform a jump link acquisition operation if a trigger signal of the jump component is received, and acquire a to-be-jumped link from the multiple jump links through the jump link acquisition operation.

The jump operation execution module is configured to perform a jump operation so that the first page jumps to a second page associated with the to-be-jumped link.

The jump failure processing module is configured to perform the jump link acquisition operation and the jump operation again if the jump operation fails, until the jump operation succeeds or there is no to-be-jumped link.

The jump link acquisition module includes a priority acquiring module and a to-be-jumped link acquisition module.

The priority acquisition module is configured to acquire priorities of multiple jump links if a click signal for the jump component is received.

The to-be-jumped link acquisition module is configured to acquire a jump link with a highest priority among the multiple jump links as the to-be-jumped link.

The jump operation execution module includes a jump link type determining module and a first invoking module.

The jump link type determining module is configured to determine a type of the to-be-jumped link.

The first invoking module is configured to invoke programs corresponding to the type of the to-be-jumped link to open the to-be-jumped link.

The page jump apparatus includes a match determining module and a first jump link acquisition module.

The match determining module is configured to determine whether a type of a terminal device where the first page is located matches with the to-be-jumped link.

The first jump link acquisition module is configured to perform the jump link acquisition operation again if the type of the terminal device does not match with the to-be-jumped link.

The jump operation execution module includes a timer starting module and a second invoking module.

The timer starting module is configured to start a first timer.

The second invoking module is configured to invoke programs corresponding to the to-be-jumped link to open the to-be-jumped link.

The jump failure processing module includes a first page determining module and a first jump failure processing module.

The first page determining module is configured to determine whether a page currently displayed is the first page, when the first timer times out.

The first jump failure processing module is configured to perform the jump link acquisition operation and the jump operation again if the page currently displayed is the first page, until the jump operation succeeds or there is no to-be-jumped link.

The page jump apparatus further includes a setting signal receiving module, configured to receive a setting signal of the jump component. The setting signal is used for setting multiple jump links associated with the jump component.

According to one or more more embodiments of the present disclosure, an electronic device is provided. The electronic device includes: at least one processor; and a memory in communication connection with the at least one processor. The memory stores instructions executable by the at least one processor. The instructions, when being executed by the at least processor, instruct the at least one processor to perform the page jump method according to the first aspect described above.

According to one or more embodiments of the present disclosure, a non-transitory computer readable storage medium is provided. The non-transitory computer readable storage medium stores computer instructions, which instruct a computer to perform the page jump method according to the first aspect described above.

The preferred embodiments and the technical principles of the present disclosure are described above. It should be understood by those skilled in the art that, the protection scope of the present disclosure is not limited to the technical solutions formed by specific combination of the above technical features, and other technical solutions formed by random combinations of the above technical features or equivalent features without departing from the concept of the present disclosure also fall within the protection scope of the present disclosure, for example the technical solution formed by replacement between the above technical features and technical features with similar functions disclosed (not limited)in the present disclosure.

What is claimed is:

1. A page jump method, comprising:
displaying a first page, wherein the first page comprises a jump component, and the jump component is associated with a plurality of jump links;
performing a jump link acquisition operation if a trigger signal of the jump component is received, and acquiring a to-be-jumped link from the plurality of jump links through the jump link acquisition operation;
performing a jump operation so that the first page jumps to a second page associated with the to-be-jumped link; and
performing, if the jump operation fails, the jump link acquisition operation and the jump operation again, until the jump operation succeeds or there is no to-be-jumped link.

2. The page jump method according to claim 1, wherein the performing a jump link acquisition operation if a trigger signal of the jump component is received, and acquiring a to-be-jumped link from the plurality of jump links through the jump link acquisition operation comprises:
acquiring priorities of the plurality of jump links if a click signal for the jump component is received; and
acquiring a jump link with a highest priority among the plurality of jump links as the to-be-jumped link.

3. The page jump method according to claim 1, wherein the performing a jump operation so that the first page jumps to a second page associated with the to-be-jumped link comprises:
determining a type of the to-be-jumped link; and
invoking programs corresponding to the type of the to-be-jumped link to open the to-be-jumped link.

4. The page jump method according to claim 1, wherein after the performing the jump link acquisition operation, the method further comprises:
determining whether a type of a terminal device where the first page is located matches with the to-be-jumped link; and
performing the jump link acquisition operation again if the type of the terminal device does not match with the to-be-jumped link.

5. The page jump method according to claim 1, wherein the performing a jump operation so that the first page jumps to a second page associated with the to-be-jumped link comprises:
starting a first timer; and
invoking programs corresponding to the to-be-jumped link to open the to-be-jumped link.

6. The page jump method according to claim 5, wherein the performing, if the jump operation fails, the jump link acquisition operation and the jump operation again, until the jump operation succeeds or there is no to-be-jumped link comprises:
determining whether a page currently displayed is the first page when the first timer times out; and
performing, if the page currently displayed is the first page, the jump link acquisition operation and the jump operation again, until the jump operation succeeds or there is no to-be-jumped link.

7. The page jump method according to claim 1, wherein before the displaying a first page, the method further comprises:
receiving a setting signal of the jump component, wherein the setting signal is used for setting the plurality of jump links associated with the jump component.

8. A page jump apparatus, comprising:
at least one processor; and
at least one memory communicatively coupled to the at least one processor and storing instructions that upon execution by the at least one processor cause the apparatus to:
display a first page, wherein the first page comprises a jump component, and the jump component is associated with a plurality of jump links;
perform a jump link acquisition operation if a trigger signal of the jump component is received, and acquire a to-be-jumped link from the plurality of jump links through the jump link acquisition operation;
perform a jump operation so that the first page jumps to a second page associated with the to-be-jumped link; and
perform, if the jump operation fails, the jump link acquisition operation and the jump operation again, until the jump operation succeeds or there is no to-be-jumped link.

9. (canceled)

10. A non-transitory computer readable storage medium storing a computer readable instruction, wherein the computer readable instruction, when being executed by a computer, instructs the computer to
display a first page, wherein the first page comprises a jump component, and the jump component is associated with a plurality of jump links;
perform a jump link acquisition operation if a trigger signal of the jump component is received, and acquiring a to-be-jumped link from the plurality of jump links through the jump link acquisition operation;
perform a jump operation so that the first page jumps to a second page associated with the to-be-jumped link; and
perform, if the jump operation fails, the jump link acquisition operation and the jump operation again, until the jump operation succeeds or there is no to-be-jumped link.

11. The page jump method according to claim 2, wherein after the performing the jump link acquisition operation, the method further comprises:
determining whether a type of a terminal device where the first page is located matches with the to-be-jumped link; and
performing the jump link acquisition operation again if the type of the terminal device does not match with the to-be-jumped link.

12. The apparatus of claim 8, the at least one memory further storing instructions that upon execution by the at least one processor cause the apparatus to:
acquire priorities of the plurality of jump links if a click signal for the jump component is received; and
acquire a jump link with a highest priority among the plurality of jump links as the to-be-jumped link.

13. The apparatus of claim 8, the at least one memory further storing instructions that upon execution by the at least one processor cause the apparatus to:
determine a type of the to-be-jumped link; and
invoke programs corresponding to the type of the to-be-jumped link to open the to-be-jumped link.

14. The apparatus of claim 8, the at least one memory further storing instructions that upon execution by the at least one processor cause the apparatus to:
determine whether a type of a terminal device where the first page is located matches with the to-be-jumped link; and
perform the jump link acquisition operation again if the type of the terminal device does not match with the to-be-jumped link.

15. The apparatus of claim 8, the at least one memory further storing instructions that upon execution by the at least one processor cause the apparatus to:
start a first timer; and
invoke programs corresponding to the to-be-jumped link to open the to-be-jumped link.

16. The apparatus of claim 15, the at least one memory further storing instructions that upon execution by the at least one processor cause the apparatus to:
determine whether a page currently displayed is the first page when the first timer times out; and
perform, if the page currently displayed is the first page, the jump link acquisition operation and the jump operation again, until the jump operation succeeds or there is no to-be-jumped link.

17. The apparatus of claim 8, the at least one memory further storing instructions that upon execution by the at least one processor cause the apparatus to:
receive a setting signal of the jump component, wherein the setting signal is used for setting the plurality of jump links associated with the jump component.
